(19) United States
(12) Patent Application Publication
(10) Pub. No.: US 2014/0204895 A1
(43) Pub. Date: Jul. 24, 2014

(54) Remote-Site Operation

(71) Applicant: NOKIA SOLUTIONS AND NETWORKS OY, Espoo (FI)

(72) Inventors: Frank Frederiksen, Klarup (DK); Troels Emil Kolding, Klarup (DK)

(21) Appl. No.: 14/239,667

(22) PCT Filed: Aug. 19, 2011
(86) PCT No.: PCT/EP2011/064268

§ 371 Date: Feb. 19, 2014

(51) Int. Cl. H04W 4/00

(52) U.S. Cl. CPC H04W 4/003
USPC 370/329

(57) ABSTRACT

The invention relates to an apparatus comprising at least one processor and at least one memory including a computer program code, the at least one memory and the computer program code configured to, with the at least one processor, cause the apparatus at least to: store information needed for executing at least one operation by a remote-site, and carry out the at least one operation by the remote-site by using the stored information, if mobile fronthaul is temporarily not available.

### FIELD

The invention relates to apparatuses, methods, a system, computer programs, computer program products and computer-readable media.

### BACKGROUND

The following description of background art may include insights, discoveries, understandings or disclosures, or associations together with disclosures not known to the relevant art prior to the present invention but provided by the invention. Some such contributions of the invention may be specifically pointed out below, whereas other such contributions of the invention will be apparent from their context.

Modern multimedia devices enable providing users with more services. The usage of multimedia services increases the demand for rapid data transfer which in turn requires investments in radio networks. This has brought cost-effective technologies and network architectures, which also support sustainable development into the beam of light.

### BRIEF DESCRIPTION

According to an aspect of the present invention, there is provided an apparatus comprising: at least one processor and at least one memory including a computer program code, the at least one memory and the computer program code configured to, with the at least one processor, cause the apparatus at least to: store information needed for executing at least one operation by a remote-site, and carry out the at least one operation by the remote-site by using the stored information, if mobile fronthaul is temporarily not available.

According to yet another aspect of the present invention, there is provided a method comprising: storing information needed for executing at least one operation by a remote-site, and carrying out the at least one operation by the remote-site by using the stored information, if mobile fronthaul is temporarily not available.

According to yet another aspect of the present invention, there is provided an apparatus comprising: means for storing information needed for executing at least one operation by a remote-site, and means for carrying out the at least one operation by the remote-site by using the stored information, if mobile fronthaul is temporarily not available.

According to yet another aspect of the present invention, there is provided a computer program embodied on a computer-readable storage medium, the computer program comprising program code for controlling a process to execute a process, the process comprising: storing information needed for executing at least one operation by a remote-site, an carrying out the at least one operation by the remote-site by using the stored information, if mobile fronthaul is temporarily not available.

### LIST OF DRAWINGS

Some embodiments of the present invention are described below, by way of example only, with reference to the accompanying drawings, in which

FIGS. 1A and 1B illustrate examples of systems;

FIG. 2 is a flow chart;

FIG. 3 illustrates examples of apparatuses.

### DESCRIPTION OF EMBODIMENTS

The following embodiments are only examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments.

Embodiments are applicable to any user device, such as a user terminal, relay node, server, node, corresponding component, and/or to any communication system or any combination of different communication systems that support required functionalities. The communication system may be a wireless communication system or a communication system utilizing both fixed networks and wireless networks. The protocols used, the specifications of communication systems, apparatuses, such as servers and user terminals, especially in wireless communication, develop rapidly. Such development may require extra changes to an embodiment. Therefore, all words and expressions should be interpreted broadly and they are intended to illustrate, not to restrict, embodiments.

In the following, different exemplifying embodiments will be described using, as an example of an access architecture to which the embodiments may be applied, a radio access architecture based on long term evolution advanced (LTE Advanced, LTE-A), that is based on orthogonal frequency multiplexed access (OFDMA) in a downlink and a single-carrier frequency-division multiple access (SC-FDMA) in an uplink, without restricting the embodiments to such an architecture, however. It is obvious for a person skilled in the art that the embodiments may also be applied to other kinds of communications networks having suitable means by adjusting parameters and procedures appropriately.

In an orthogonal frequency division multiplexing (OFDM) system, the available spectrum is divided into multiple orthogonal sub-carriers. In OFDM systems, the available bandwidth is divided into narrower sub-carriers and data is transmitted in parallel streams. Each OFDM symbol is a linear combination of signals on each of the subcarriers. Further, each OFDM symbol is preceded by a cyclic prefix (CP), which is used to decrease Inter-Symbol Interference. Unlike in OFDM, SC-FDMA subcarriers are not independently modulated.

Typically, a (e)NodeB (“e” stands for evolved) needs to know channel quality of each user device and/or the preferred precoding matrices (and/or other multiple input-multiple output (MIMO) specific feedback information, such as channel quantization) over the allocated sub-bands to schedule transmissions to user devices. Such required information is usually signalled to the (e)NodeB.

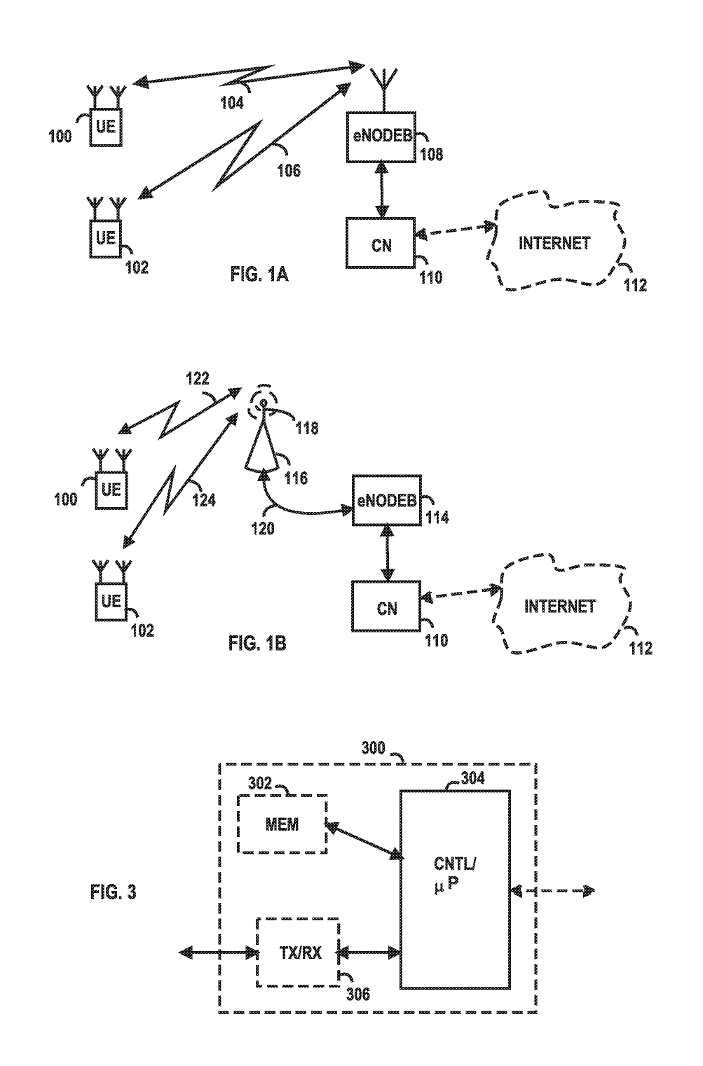

FIG. 1A depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

FIG. 1A shows a part of a radio access network based on E-UTRA, LTE, LTE-Advanced (LTE-A) or LTE/EPC (EPC=evolved packet core, EPC is enhancement of packet switched technology to cope with faster data rates and growth of Internet protocol traffic). E-UTRA is an air interface of Release 8 (UTRA=UMTS terrestrial radio access, UMTS=universal mobile telecommunications system). Some advantages obtainable by LTE (or E-UTRA) are a possibility to use plug and play devices, and Frequency Division Duplex (FDD) and Time Division Duplex (TDD) in the same platform.

FIG. 1A shows user devices 100 and 102 configured to be in a wireless connection on one or more communication channels 104, 106 in a cell with a (e)NodeB 108 providing the cell. The physical link from a user device to a (e)NodeB is called uplink or reverse link and the physical link from the NodeB to the user device is called downlink or forward link.

The NodeB, or advanced evolved node B (eNodeB, eNB) in LTE-Advanced, is a computing device configured to control the radio resources of communication system it is coupled to. The (e)NodeB may also be referred to as a base station, an access point or any other type of interfacing device including a relay station capable of operating in a wireless environment.

The (e)NodeB includes transceivers, for example. From the transceivers of the (e)NodeB, a connection is provided to an antenna unit that establishes bi-directional radio links to user devices. The antenna unit may comprise a plurality of antennas or antenna elements.

The (e)NodeB is further connected to core network 110 (CN). Depending on the system, the counterpart on the CN side can be a serving gateway (S-GW, routing and forwarding user data packets), packet data network gateway (P-GVV), for providing connectivity of user devices (UEs) to external packet data networks, or mobile management entity (MME), etc.

A communications system typically comprises more than one (e)NodeB in which case the (e)NodeBs may also be configured to communicate with one another over links, wired or wireless, designed for the purpose. These links may be used for signalling purposes.

The communication system is also able to communicate with other networks, such as a public switched telephone network or the Internet 112. The communication network may also be able to support the usage of cloud services. It should be appreciated that (e)NodeBs or their functionalities may be implemented by using any node, host, server or access point etc. entity suitable for such a usage.

The user device (also called UE, user equipment, user terminal, terminal device, etc.) illustrates one type of an apparatus to which resources on the air interface are allocated and assigned, and thus any feature described herein with a user device may be implemented with a corresponding apparatus, such as a relay node. An example of such a relay node is a layer 3 relay (self-backhauling relay) towards the base station.

The user device typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device.

The user device (or in some embodiments a layer 3 relay node) is configured to perform one or more of user equipment functionalities. The user device may also be called a subscriber unit, mobile station, remote terminal, access terminal, user terminal or user equipment (UE) just to mention but a few names or apparatuses.

It should be understood that, in FIG. 1A, user devices are depicted to include 2 antennas only for the sake of clarity. The number of reception and/or transmission antennas may naturally vary according to a current implementation.

Further, although the apparatuses have been depicted as single entities, different units, processors and/or memory units (not all shown in FIG. 1) may be implemented.

It is obvious for a person skilled in the art that the depicted system is only an example of a part of a radio access system and in practise, the system may comprise a plurality of (e)NodeBs, the user device may have an access to a plurality of radio cells and the system may comprise also other apparatuses, such as physical layer relay nodes or other network elements, etc. At least one of the NodeBs or eNodeBs may be a Home(e)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometres, or smaller cells such as micro-, femto- or picocells. The (e)NodeB 108 of FIG. 1A may provide any kind of these cells. A cellular radio system may be implemented as a multilayer network including several kinds of cells. Typically, in multilayer networks, one node B provides one kind of a cell or cells, and thus a plurality of node Bs are required to provide such a network structure.

Modern multimedia devices enable providing users with more services. The usage of multimedia services increases the demand for rapid data transfer which in turn requires investments in radio networks. Developed networks enabling an adequate user experience when modern services and applications are used, typically means higher installation and operating expenses (OPEX). Further, as the power consumption of a base station typically maps directly into the operational expenses (OPEX) of a network operator, technologies enabling reduction of energy consumption of a network have been a focus of interest.

One means to be used in improving the usage of network resources in a cost-effective way is introducing remote radio frequency (RF) heads and base station hotels or base band hotels. In this concept, a base station is split into two parts: a remote RF head and a baseband radio server typically coupled by a wired link (a wireless link is also possible). This produces a system wherein baseband radio servers may be deployed in an easy-to-access and/or low-cost location while remote radio frequency (RF) heads (RRHs) may be mounted on the rooftop close to an antenna. Usually, a remote RF head houses radio-related functions (transmitter RF, receiver RF, filtering etc.) and the base station part carries out other base station functions, such as base band functions. Each radio head may produce a separately controlled cell, but they may also constitute a cluster of cells with distributed antennas. Additionally, a set of remote radio heads may create a single cell.

Further, multiple baseband radio servers may be placed in a same location, utilizing same resources, such as power supplies and backhaul connections, while RF heads may be distributed at locations providing desired radio coverage. This concept is supported by open base station architecture initiative (OBSAI) specifications and/or common public radio interface (CPRI). The OBSAI is an initiative to create open interface specifications related to key parts of the base station subsystem and the CPRI is cooperation defining publicly available specification for the key internal interface of radio base stations between radio equipment control (REC) and radio equipment (RE). These initiatives are targeted to introduce a standardized split between base station elements, for instance between a base station's (eNB) baseband unit and a remote radio head (RRH) which handle the conversion of a baseband signal to a desired radio carrier and vice versa. The centralized base station may be referred as a base station (BTS) hotel. Base station hotels or base band hotels with extensive integration and joint processing are also referred to as cloud RAN (C-RAN).

One advantage of the base station (BTS) or base band hotel architecture lies in its ability to provide cost-effective BTS redundancy.

FIG. 1B shows an example how the base station (BTS) or base band hotel concept may be implemented in the system of FIG. 1A. Similar reference numbers refer to similar units, elements, connections etc. Only differences between FIGS. 1A and 1B are explained in this context.

The base station (BTS) or base band hotel concept is taken herein only as an example. However, embodiments are not restricted to this concept. For example, the embodiments are applicable to networks, wherein nodes are coupled with optical fibre.

In FIG. 1B, a remote-site, such as a radio head 116 is placed near antenna 118 and the rest of the base station (in this example eNodeB) 114 is located in a centralized position which may be suitable for multiple base stations. In this example, the link between the radio head 116 and the base station 114 is implemented with an optical fibre connection 120. The eNodeB may include base band functions and thus be called as a base band hotel. The radio connections 122 and 124 between user devices 100 and 102 are provided by the remote-site 116.

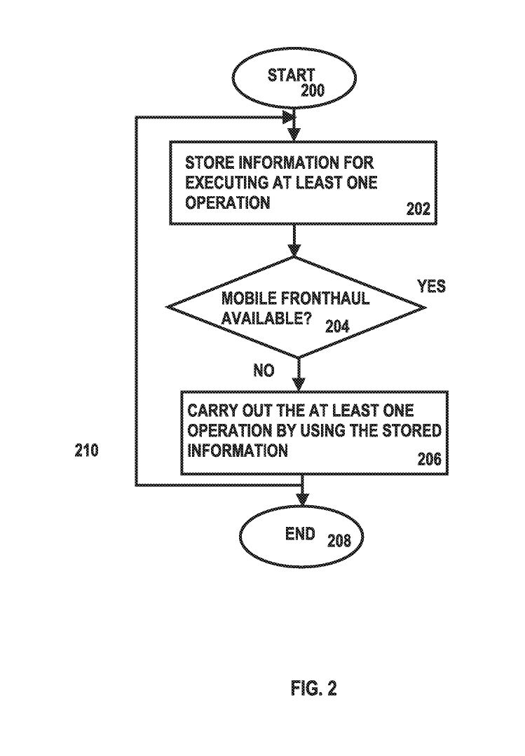

In the following, some embodiments are disclosed in further details in relation to FIG. 2. The embodiment of FIG. 2 may be related to a remote radio unit or remote site operationally coupled to a base station, node, host, server etc. provided with required functionality to carry out base station and/or radio network controller functionalities excluding radio functionalities.

Signal samples after a digital front-end are usually transmitted over an interface between a remote radio head and a central processing unit of a base band or BTS hotel. That requires a plenty of capacity in the transmission path as well as in the central processing unit. Since the remote radio head and its central processing unit may be located at a distance from each other, costs usually play an important role and the reduction of a required data rate is an issue of interest.

In the current development of base station equipment, a tendency of introducing a plurality of interfaces in order to introduce a layered approach in terms of hardware architecture exists. Examples of such interfaces are common public radio interface (CPRI) and the open base station architecture initiative (OBSAI) as already stated above. Next generation interface for this split has already been discussed for standardization and is denoted OBRI/ORI that is to say open base band radio interface/open radio equipment interface or open base band unit (BBU) remote radio head (RRH) interface. The open BBU RRH interface is a project of the European telecommunications standards institute (ETSI) industry specification group (ISG).

A plurality of options for functionality split exists. The interface between a remote site and a hotel is denoted a mobile fronthaul (MFH). An option compatible with common public radio interface (CPRI) and open base station architecture initiative (OBSAI) specifications is that the remote site carries out only tasks of a currently specified remote radio head. This option requires a very fast fibre connection with strict timing requirements. Because of considerations of low cost transportation, a different split between the base band hotel and remote site may be considered as well. One possibility is that the remote site takes also care for layer 1 operations as a whole or even layer 2 operations (layers 1 and 2 refer to open systems interconnection model (OSI model) layers).

Another example of corresponding flexible architectures is a so-called liquid radio which enables sharing and redistributing available capacity based on user demand. According to the liquid radio, typically, radio frequency elements and antenna(s) become active, sized and positioned according to a need, while baseband processing is pooled and sited remotely. The baseband processing may be shared with several remote sites for capacity being dynamically used where needed.

A need exists to develop arrangements which provide relaxed transport requirements, such as lower latency requirements, and also ability to support packet switching techniques, such as gigabit Ethernet, to host a plurality of radio sites using a same fibre cable or other means as a mobile fronthaul. However, such arrangements may have interruptions in the mobile fronthaul due to outages, for example, causing that signalling between a remote site and a base band hotel does not necessary fulfil timing requirements. It is assumed that such failures take place at least relatively seldom, but they still may cause the operational connection between the remote site and the base band hotel to become congested and data transfer thus delayed.

An embodiment starts in block 200.

In block 202, information needed for executing at least one operation by a remote-site is stored.

The storing may be carried out by using one or more possibly pre-configured buffers. The format may be a table and the information may be with regard to what is to be transmitted for given subframes, and for which time instants in different subframes.

The at least one operation may include at least one time-dependent operation.

Examples of possible operations are radio frequency operations, layer 1 operations, as well as layer 1 and layer 2 operations.

In the case the remote-site is a part of an LTE-system, the pre-configured buffer may contain information needed for basic cell operation, such as at least one of the following: output data corresponding to the transmission of common reference symbols, a (dummy) physical control format indication channel (PCFICH), (dummy) physical hybrid automatic repeat request (HARQ) indicator channel (PHICH), physical broadcast channel (PBCH), primary and/or secondary synchronization channels (PSS and SSS), common reference signal (CRS) as well as physical downlink control channel (PDCCH) and SI-x transmission which may also be needed for some subframes to convey additional cell-level information. If the remote-site is a part of a WCDMA-system, radio frequency equipment may be configured to transmit some idle mode signals consisting of a common pilot channel (CPICH) as well as synchronization channels. As indicated in the list above, PCFICH and/or PHICH channels may include “dummy” information or be characterized as “dummy” channels. In this context, term “dummy” is used mainly to emphasize the difference between common signaling and an embodiment: in general, in this context, dummy may mean transmitting information that is intended for a non-existing user (that is a dummy user). Thus, dummy signaling information may mean default signaling information to enable user devices to receive signaling information needed for continued operation. For example, a dummy PCHICH channel may carry a default value that enables user devices to receive and decode a PHICH channel signal needed for uplink operation. In the PHICH channel, an acknowledgement (ACK) message may be transmitted to make the user device to stop transmitting. In the case the reception of uplink data fails, a retransmission may be requested by scheduling the user device in question for a non-adaptive retransmission.

SI-x transmission typically includes a set of different system information bearers (SIB), ranging from 1 to 12 or 13 (3 GPP TS 36.331). System information bearers are system control channels informing user devices about system configuration (basic parameters, handover setup, idle mode procedures, handover candidates, etc.).

Some more detailed examples are shown in Tables 1 and 2 below:

TABLE 1

| LTE subframe | | |
|---|---|---|
| number | To be transmitted | Note |
| 0 | PSS, SSS, PBCH, CRS, | Variable transmission for |
| | Dummy PCFICH, Dummy | different time instants |
| | PHICH | (OFDM symbols) |
| 5 | PSS, SSS, SI-1, CRS, | Variable transmission for |
| | Dummy PCFICH, Dummy | different time instants |
| | PHICH | (OFDM symbols) |
| 1, 2, 3, 4, 5, | CRS; Dummy PCFICH, | Variable transmission for |
| 6, 7, 8, 9 | Dummy PHICH | different time instants |
| | | (OFDM symbols) |

The time variable transmission for different time instants mentioned above in Table 1 may be:

TABLE 2

| OFDM symbol | To be transmitted | Note |
|---|---|---|
| 0 | CRS, Dummy PCFICH, | — |
| | Dummy PHICH | |
| 1, 2, 3, 12, 13 | — | power amplifier may be |
| | | switched-off |
| 4, 11 | CRS | — |
| 5 | PSS | For limited bandwidth |
| 6 | SSS | For limited bandwidth |
| 7 | CRS, PBCH | — |
| 8, 9, 10 | PBCH | — |

In block 206, the at least one operation is carried out by the remote-site by using the stored information, if mobile fronthaul is temporarily not available (block 204).

The at least one operation may include at least one time-dependent operation.

Examples of possible operations are radio frequency operations, layer 1 operations, as well as layer 1 and layer 2 operations.

The remote-site may be configured to carry out one or more operations, if a source signal is missing for a single or a few subframes.

Examples of possible operations in an LTE-system are: transmission of common reference symbols, transmission of a physical control format indication channel (PCFICH), transmission of a physical hybrid automatic repeat request (HARQ) indicator channel (PHICH), transmission of a physical broadcast channel (PBCH), transmission of primary and/or secondary synchronization channels (PSS and SSS), transmission of a common reference signal (CRS), transmission of a physical downlink control channel (PDCCH) and a SI-x transmission. As already indicated above, some operations may be based on “dummy” information.

Examples of possible operations in a WCDMA-system are: transmission of some idle mode signals consisting of a common pilot channel (CPICH) as well as synchronization channels.

If several consecutive subframes from a baseband hotel are missing, a remote-site may switch itself off to prevent having a non-functioning cell (which is the case when no traffic is being scheduled).

It should be appreciated that different variants of the layer split presented above will offer different options in terms of autonomous operation. For instance, if a remote-site carries out layer 1 operations, the remote-site may be allowed to “hook” its downlink transmission (generation of PHICH signals) to the uplink reception (output of turbo decoder and subsequent cyclic redundancy check decoding) to provide tentative scheduling decisions. If no centralized scheduling decision is obtained from the baseband hotel, the “hook” may be implemented by using no-acknowledgement (NACK) indication on the PHICH.

An embodiment provides a possibility to continue basic cell operation during a small “hick-up” of a mobile fronthaul. This in turn enables a user device to continue its operation without a drop of a connection, for example.

The embodiment ends in block 208. The embodiment is repeatable in many ways. One example is shown by arrow 210 in FIG. 2.

The steps/points, signaling messages and related functions described above in FIG. 2 are in no absolute chronological order, and some of the steps/points may be performed simultaneously or in an order differing from the given one. Other functions may also be executed between the steps/points or within the steps/points and other signaling messages sent between the illustrated messages. Some of the steps/points or part of the steps/points can also be left out or replaced by a corresponding step/point or part of the step/point.

It should be understood that conveying, transmitting and/or receiving may herein mean preparing a data conveyance, transmission and/or reception, preparing a message to be conveyed, transmitted and/or received, or physical transmission and/or reception itself, etc. on a case by case basis.

An embodiment provides an apparatus which may be any remote-site, radio head, user device, web stick, server, node (home node, relay node, etc.), host or any other suitable apparatus capable to carry out processes described above in relation to FIG. 2.

FIG. 3 illustrates a simplified block diagram of an apparatus according to an embodiment.

As an example of an apparatus according to an embodiment, it is shown an apparatus 300, such as a remote-site or radio head, including facilities in a control unit 304 (including one or more processors, for example) to carry out functions of embodiments according to FIG. 2.

In FIG. 3, block 306 includes parts/units/modules needed for reception and transmission, usually called a radio front end, RF-parts, radio parts, etc.

Another example of an apparatus 300 may include at least one processor 304 and at least one memory 302 including a computer program code, the at least one memory and the computer program code configured to, with the at least one processor, cause the apparatus at least to: store information needed for executing at least one operation by a remote-site, and carry out the at least one time-dependent operation by the remote-site by using the stored information, if mobile fronthaul is temporarily not available.

Yet another example of an apparatus comprises means 304 for storing information needed for executing at least one operation by a remote-site, and means 304 for carrying out the at least one time-dependent operation by the remote-site by using the stored information, if mobile fronthaul is temporarily not available.

Yet another example of an apparatus comprises a storage unit configured to storage information needed for executing at least one time-dependent operation by a remote-site, and a processor configured to carry out the at least one operation by the remote-site by using the stored information, if mobile fronthaul is temporarily not available.

It should be understood that the apparatuses may include or be coupled to other units or modules etc, such as radio parts or radio heads, used in or for transmission and/or reception. This is depicted in FIG. 3 as an optional block 306.

Although the apparatuses have been depicted as one entity in FIG. 3, different modules and memory may be implemented in one or more physical or logical entities.

An apparatus may in general include at least one processor, controller or a unit designed for carrying out control functions operably coupled to at least one memory unit and to various interfaces. Further, the memory units may include volatile and/or non-volatile memory. The memory unit may store computer program code and/or operating systems, information, data, content or the like for the processor to perform operations according to embodiments. Each of the memory units may be a random access memory, hard drive, etc. The memory units may be at least partly removable and/or detachably operationally coupled to the apparatus. The memory may be of any type suitable for the current technical environment and it may be implemented using any suitable data storage technology, such as semiconductor-based technology, flash memory, magnetic and/or optical memory devices. The memory may be fixed or removable.

The apparatus may be a software application, or a module, or a unit configured as arithmetic operation, or as a program (including an added or updated software routine), executed by an operation processor. Programs, also called program products or computer programs, including software routines, applets and macros, may be stored in any apparatus-readable data storage medium and they include program instructions to perform particular tasks. Computer programs may be coded by a programming language, which may be a high-level programming language, such as objective-C, C, C++, Java, etc., or a low-level programming language, such as a machine language, or an assembler.

Modifications and configurations required for implementing functionality of an embodiment may be performed as routines, which may be implemented as added or updated software routines, application circuits (ASIC) and/or programmable circuits. Further, software routines may be downloaded into an apparatus. The apparatus, such as a node device, or a corresponding component, may be configured as a computer or a microprocessor, such as single-chip computer element, or as a chipset, including at least a memory for providing storage capacity used for arithmetic operation and an operation processor for executing the arithmetic operation.

Embodiments provide computer programs embodied on a distribution medium, comprising program instructions which, when loaded into electronic apparatuses, constitute the apparatuses as explained above. The distribution medium may be a non-transitory medium.

Other embodiments provide computer programs embodied on a computer readable storage medium, configured to control a processor to perform embodiments of the methods described above. The computer readable storage medium may be a non-transitory medium.

The computer program may be in source code form, object code form, or in some intermediate form, and it may be stored in some sort of carrier, distribution medium, or computer readable medium, which may be any entity or device capable of carrying the program. Such carriers include a record medium, computer memory, read-only memory, electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

The techniques described herein may be implemented by various means. For example, these techniques may be implemented in hardware (one or more devices), firmware (one or more devices), software (one or more modules), or combinations thereof. For a hardware implementation, the apparatus may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, digitally enhanced circuits, other electronic units designed to perform the functions described herein, or a combination thereof. For firmware or software, the implementation may be carried out through modules of at least one chip set (e.g., procedures, functions, and so on) that perform the functions described herein. The software codes may be stored in a memory unit and executed by processors. The memory unit may be implemented within the processor or externally to the processor. In the latter case it may be communicatively coupled to the processor via various means, as is known in the art. Additionally, the components of systems described herein may be rearranged and/or complimented by additional components in order to facilitate achieving the various aspects, etc., described with regard thereto, and they are not limited to the precise configurations set forth in the given figures, as will be appreciated by one skilled in the art.

It will be obvious to a person skilled in the art that, as technology advances, the inventive concept may be implemented in various ways. The invention and its embodiments are not limited to the examples described above but may vary within the scope of the claims.

1-33. (canceled)

34. An apparatus comprising:
at least one processor and at least one memory including a computer program code, the at least one memory and the computer program code configured to, with the at least one processor, cause the apparatus at least to:
store information needed for executing at least one operation by a remote-site, and
carry out the at least one operation by the remote-site by using the stored information, if mobile fronthaul is temporarily not available.

35. The apparatus of claim 34, wherein the remote-site comprises a remote radio head operably coupled to a base band hotel.

36. The apparatus of claim 34, wherein the at least one operation comprises at least one time-dependent operation.

37. The apparatus of claim 34, wherein the at least one operation comprises at least one radio frequency operation.

38. The apparatus of claim 34, wherein the at least one operation comprises at least one layer 1 operation.

39. The apparatus of claim 34, wherein the at least one operation comprises at least one layer 1 and layer 2 operation.

40. The apparatus of claim 34, wherein the storing is carried out by using a table and the information is with regard to what is to be transmitted for given subframes, and for which time instants in different subframes.

41. The apparatus of claim 34, wherein the information comprises at least one of the following: output data corresponding to the transmission of common reference symbols, a physical control format indication channel (PCFICH), physical hybrid automatic repeat request (HARQ) indicator channel (PHICH), physical broadcast channel (PBCH), primary and/or secondary synchronization channels (PSS and SSS), common reference signal (CRS), physical downlink control channel (PDCCH), SI-x transmission, idle mode signals consisting of a common pilot channel (CPICH), and synchronization channels.

42. The apparatus of claim 34, wherein the at least one operation is at least one of the following: transmission of common reference symbols, transmission of a physical control format indication channel (PCFICH), transmission of a physical hybrid automatic repeat request (HARQ) indicator channel (PHICH), transmission of a physical broadcast channel (PBCH), transmission of primary and/or secondary synchronization channels (PSS and SSS), transmission of a common reference signal (CRS), transmission of a physical downlink control channel (PDCCH) and a SI-x transmission, transmission of idle mode signals consisting of a common pilot channel (CPICH), and transmission of synchronization channels.

43. The apparatus of claim 34, wherein the information comprises at least one of the following: output data corresponding to the transmission of common reference symbols, a physical control format indication channel (PCFICH), physical hybrid automatic repeat request (HARQ) indicator channel (PHICH), physical broadcast channel (PBCH), primary and/or secondary synchronization channels (PSS and SSS), common reference signal (CRS), physical downlink control channel (PDCCH), SI-x transmission, idle mode signals consisting of a common pilot channel (CPICH), and synchronization channels, and wherein the information with regard to at least one of the following: a physical control format indication channel (PCFICH) and physical hybrid automatic repeat request (HARQ) indicator channel (PHICH), is information targeted to a non-existing user.

44. The apparatus of claim 34, wherein the at least one operation is at least one of the following: transmission of common reference symbols, transmission of a physical control format indication channel (PCFICH), transmission of a physical hybrid automatic repeat request (HARQ) indicator channel (PHICH), transmission of a physical broadcast channel (PBCH), transmission of primary and/or secondary synchronization channels (PSS and SSS), transmission of a common reference signal (CRS), transmission of a physical downlink control channel (PDCCH) and a SI-x transmission, transmission of idle mode signals consisting of a common pilot channel (CPICH), and transmission of synchronization channels.

45. A method comprising:
storing information needed for executing at least one operation by a remote-site, and
carrying out the at least one operation by the remote-site by using the stored information, if mobile fronthaul is temporarily not available.

46. The method of claim 45, wherein the remote-site comprises a remote radio head operably coupled to a base band hotel.

47. The method of claim 45, wherein the at least one operation comprises at least one time-dependent operation.

48. The method of claim 45, wherein the at least one operation comprises at least one radio frequency operation.

49. The method of claim 45, wherein the at least one operation comprises at least one layer 1 operation.

50. The method of claim 45, wherein the at least one operation comprises at least one layer 1 and layer 2 operation.

51. The method of claim 45, wherein the storing is carried out by using a table and the information is with regard to what is to be transmitted for given subframes, and for which time instants in different subframes.

52. The method of claim 45, wherein the information comprises at least one of the following: output data corresponding to the transmission of common reference symbols, a physical control format indication channel (PCFICH), physical hybrid automatic repeat request (HARQ) indicator channel (PHICH), physical broadcast channel (PBCH), primary and/or secondary synchronization channels (PSS and SSS), common reference signal (CRS), physical downlink control channel (PDCCH), SI-x transmission, idle mode signals consisting of a common pilot channel (CPICH), and synchronization channels.

53. The method of claim 45, wherein the at least one operation is at least one of the following: transmission of common reference symbols, transmission of a physical control format indication channel (PCFICH), transmission of a physical hybrid automatic repeat request (HARQ) indicator channel (PHICH), transmission of a physical broadcast channel (PBCH), transmission of primary and/or secondary synchronization channels (PSS and SSS), transmission of a common reference signal (CRS), transmission of a physical downlink control channel (PDCCH), a SI-x transmission, transmission of idle mode signals consisting of a common pilot channel (CPICH), and transmission of synchronization channels.

54. The method of claim 45, wherein the information comprises at least one of the following: output data corresponding to the transmission of common reference symbols, a physical control format indication channel (PCFICH), physical hybrid automatic repeat request (HARQ) indicator channel (PHICH), physical broadcast channel (PBCH), primary and/or secondary synchronization channels (PSS and SSS), common reference signal (CRS), physical downlink control channel (PDCCH), SI-x transmission, idle mode signals consisting of a common pilot channel (CPICH), and synchronization channels, and wherein the information with regard to at least one of the following: a physical control format indication channel (PCFICH) and physical hybrid automatic repeat request (HARQ) indicator channel (PHICH), is information targeted to a non-existing user.

55. The method of claim 45, wherein the at least one operation is at least one of the following: transmission of common reference symbols, transmission of a physical control format indication channel (PCFICH), transmission of a physical hybrid automatic repeat request (HARQ) indicator channel (PHICH), transmission of a physical broadcast channel (PBCH), transmission of primary and/or secondary synchronization channels (PSS and SSS), transmission of a common reference signal (CRS), transmission of a physical downlink control channel (PDCCH), a SI-x transmission, transmission of idle mode signals consisting of a common pilot channel (CPICH), and transmission of synchronization channels.

56. A computer program embodied on a computer-readable storage medium, the computer program comprising program code for controlling a process to execute a process, the process comprising:
storing information needed for executing at least one operation by a remote-site, and
carrying out the at least one operation by the remote-site by using the stored information, if mobile fronthaul is temporarily not available.

57. The computer program of claim 56, wherein the remote-site comprises a remote radio head operably coupled to a base band hotel.

58. The computer program of claim 56, wherein the at least one operation comprises at least one time-dependent operation.

59. The computer program of claim 56, wherein the at least one operation comprises at least one radio frequency operation.

60. The computer program of claim 56, wherein the at least one operation comprises at least one layer 1 operation.

61. The computer program of claim 56, wherein the at least one operation comprises at least one layer 1 and layer 2 operation.

62. The computer program of claim 56, wherein the storing is carried out by using a table and the information is with regard to what is to be transmitted for given subframes, and for which time instants in different subframes.

63. The computer program of claim 56, wherein the information comprises at least one of the following: output data corresponding to the transmission of common reference symbols, a physical control format indication channel (PCFICH), physical hybrid automatic repeat request (HARQ) indicator channel (PHICH), physical broadcast channel (PBCH), primary and/or secondary synchronization channels (PSS and SSS), common reference signal (CRS), physical downlink control channel (PDCCH), SI-x transmission, idle mode signals consisting of a common pilot channel (CPICH), and synchronization channels.

64. The computer program of claim 56, wherein the at least one operation is at least one of the following: transmission of common reference symbols, transmission of a physical control format indication channel (PCFICH), transmission of a physical hybrid automatic repeat request (HARQ) indicator channel (PHICH), transmission of a physical broadcast channel (PBCH), transmission of primary and/or secondary synchronization channels (PSS and SSS), transmission of a common reference signal (CRS), transmission of a physical downlink control channel (PDCCH), a SI-x transmission, transmission of idle mode signals consisting of a common pilot channel (CPICH), and transmission of synchronization channels.
